(19) United States
(12) Patent Application Publication
(10) Pub. No.: US 2002/0193452 A1
(43) Pub. Date: Dec. 19, 2002

(54) Use of a water-soluble agent containing polyglycerols for the lubrication of extrusions, in particular strips

(76) Inventors: Erich Brocker, Kirchberg (CH); Hans-Jurgen Maier, Wald-Oberholz (CH)

Correspondence Address: NATH & ASSOCIATES, 1030 15th STREET, 6TH FLOOR, WASHINGTON, DC, 20005, US

(21) Appl. No.: 10/149,062

(22) PCT Filed: Dec. 19, 2000
(86) PCT No.: PCT/CH00/00670

(30) Foreign Application Priority Data
Dec. 30, 1999 (EP) 99811218.9

(51) Int. Cl. C09K 3/00

(52) U.S. Cl. 516/53

(57) ABSTRACT

A lubricant for the lubrication of extrusions, preferably strips 4, 4a, made of a biopolymeric substance, in particular of gelatin, in a work process and a method of manufacturing soft gelatin capsules, wherein the lubricant is water-soluble and contains one or more polyglycerols having 2-28 monomeric units, preferably 2-10 monomeric units. The advantage of the hydrophilic lubricant is that it becomes obsolete to remove the residual lubricant on the capsule's wrapper before the drying of the capsules 8 as well as the possible recycling of the lattices of waste 14.

The subject of the present invention is the use of a water-soluble agent containing at least one polyglycerol for the lubrication of extrusions, in particular strips made of a biopolymeric substance in a work process containing at least the conveyance of the extrusions, a method of manufacturing single dose formulations and the reuse of waste being mixed with such a lubricant according to the independent claims 1, 8, 10 and 13 of such a work process.

Soft capsules are ideal as packages of oils, of lipophil suspensions as well as of suspensions based on hydrophilic polymers. In particular they make single dose formulations possible. The applications are varied and comprise the fields of technique, food, health and cosmetics. The most efficient manufacturing of soft capsules is performed according to the rotary-die-method, first described in the U.S. Pat. No. 2,288,327. The shaping of the wrapper, its filling as well as the closing of the capsule is performed in one single operation at the capsule filling station by welding two endless loops of gelatin or another biopolymer between two shaping rollers rotating as punching tool (also see Bauer, K., ,Die Herstellung von Hart- and Weichgelatinekapseln’ in “Die Kapsel”, publisher Fahrig, W. et al., Wissenschaftliche Verlagsgesellschaft mbH Stuttgart 1983).

The rotary-die-method is the leading method due to the producable large scale manufacturing and in its fundamentals it has essentially stayed unchanged; this is also valid for similar methods derived from it (Norton, Accogel). One of this fundamentals is, that mineral oils or fats (triglycerides) are used as a lubricant for the tension-free supply of the strips to the capsule filling station.

The classical rotary-die-method renders possible the production of up to 100'000 capsules per hour in a continuous single operation step. A gelatine mass held liquid at about 60° C. as sol containing additives is formed over special casting devices on two cooling drums to endless, rubber-like elastic strips of about 0.8 mm in thickness and then is directed over (lubricated) deflection rollers and intermediate rollers to two rotating shaping rollers. On the cooling drums, the phase transition from sol to gel takes place by falling short of the gelling temperature of about 40° C. The both gelatin strips are joined in the small gap between the two reversely rotating shaping rollers; here the filling process and the closing process is performed. The shaping rollers serve for the welding of the gelatin strips and the punching of the obtained filled capsule. Above respectively almost between the shaping rollers the filling wedge is working, over which the filling material gets into the capsules and which integrated thermoelements generate the seal heat for the welding of the both gelatin strips along the capsule's shape. Also other thermal ductile material strips can be manufactured without problems to capsules with the rotary-die-tool.

The mineral oil or triglyceride deposited on both sides of the strips for the lubrication of the strip supply, prevents an adherence at device parts, reduces the friction and serves at the same time as a sealing means for a well setting of the filling wedge in the gap between the both strips. An airsealed closure is decisive for the pumping in of the filling material with slight pressure, wherein the capsule takes on its actual shape. At the same time the lubricant transmits the seal heat from the filling wedge to the surface of the strips and therefore to the surfaces to be welded; the filling wedge generates a temperature higher than 40° C., so that the welding of the capsule halves is caused. The lubrication of a gelatin film is for example described in EP-A-676 945.

Therefore a lubricant must show good sliding properties respectively suitable viscosities over a wide temperature range. Furthermore the lubricant may not diffuse into the strip and cause undesirable changes there or at the surface of the capsule.

Up to now mineral oils or medium-chain triglycerides were used as suitable lubricants. But from the hydrophobic nature of those lubricants also disadvantages are derived, that up to now inevitably have been taken into account for the manufacturing of capsules: Oil adhering on the capsule's inner surface detracts the fixed welding of the capsule halves and sometimes leads to leakages of the filling material. The lubricants detract the further operation, in particular the drying of the fresh capsules, which is especially performed for gelatin for lowering the water content. The thin lubricant film, in particular the oil film, on the outer surface leads to the adherence of the capsules during the drying.

Therefore the lubricant film must be removed in an additional operation step. Especially washing baths with organic solvents as e.g. methylene chloride, 1,1,1-trichlorethane, 1,1,2-trichlorethylene, naphtha, isopar, freone etc. are used. However the use of partially toxic, ecologically harmful, volatile organic solvents is undesirable or rather more inadmissible. The removal of the lubricant film with those solvents leads to high costs in the residue analysis of the final product and to regulatory difficulties (prohibited application, environmental restrictions and not eliminable contamination of the solvent due to the active substances of the formulation at the reprocessing). In particular the additional operation step of washing is undesirable, as the expense involved increases proportionally to the produced amount.

A further disadvantage of the use of these lubricants known in prior art is the contamination of the so-called lattices of waste, i.e. of the perforated strips being left after the punching of the capsules, due to the lubricant. The lattices of waste amount to approximately 30-60% of the originally used mass. Up to now the lattices of waste cannot be reused in the same or a similar method. The composition of the mass is disadvantageously changed by containing trace amounts of oil, which cannot be completely separated. At the melting, there results an oily diphasic mixture, which is not reusable.

The amount of lattices of waste, i.e. the material dismissed as reject, increases essentially the production costs. Additionally increasing in costs is the special expense of the lattice of waste's disposal. Therefore the reuse of the lattices of waste in the manufacturing process or of similar products, for which also trace amounts of mineral oils or triglycerides are not tolerable, is very desirable with respect to the costs.

Alternative methods of manufacturing soft capsules, such as the “drop and blow method”, do not reach the output capacity of the rotary-die-process or are not as robust in the process performance, which becomes apparent in a negative way e.g. in the setting of the temperature and the viscosity of the mass or in the lack of performing very viscous filling materials or pastes.

It is an object of the present invention to avoid the drawbacks of the prior art. Particularly it is an object to provide a lubricant making possible the reuse of lattices of waste being contaminated therewith. Furthermore it is an object to render a final washing step superfluous or optionally to remove the lubricant from the surface of the capsule without use of organic solvents. A further object of the present invention is no detraction of the welding of the capsule halves. Furthermore a method of reusing the lattices of waste and of forming further products should be provided.

These objects are solved by the features of the independent claims.

In particular they are solved by the use of a water-soluble agent containing at least one polyglycerol for the lubrication of extrusions made of a biopolymeric substance in a work process containing at least the conveyance of the extrusions. In particular the work process should be part of the process of manufacturing soft capsules.

Suddenly it was found out, that hydrophilic polyglycerols are suitable as lubricants for the production of shape bodies, in particular of soft capsules, according to the rotary-die-method or another similar method of manufacturing shape bodies made of a biopolymer.

The agent for the lubrication is water-soluble respectively water dispersible and comprises one or more polyglycerols, preferably consisting of 2 to 28 monomeric units. While many hydrophilic substances as for example glycerols, polyethylene glycols or propylene glycols are not suitable as lubricant, as they either lubricate insufficiently, seal insufficiently or cause undesirable changes of the gel matrix, the polyglycerols, as lubricants, combine very good sliding properties with a neutral behaviour, in particular also towards a aqueous matrix as e.g. gelatin. Besides gelatin, it is possible to use also other biopolymers made to strips or extrusions, e.g. starch, starch derivatives, cellulose, cellulose derivatives, galactomannans, rubber kinds, agar-agar, and others as well as mixtures of those biopolymers. In particular starch strips manufactured according to a new method can be used. There the strips are not casted as the gelatin, but extruded. The material can be processed at significantly higher temperatures than gelatin and contains a much lower proportion of water. However a lubrication of the strips between the extruder and the rotary-die-tool is also necessary. The new starch material is described in the European Patent application EP-99 811 071, the disclosure of which is incorporated herewith by reference into the present invention.

The polyglycerol deposited externally on the capsules or other shape bodies can be removed easily by water or physiologically harmless substances as ethanol. By using the lubricants according to the present invention the washing step, i.e. the removal of the lubricant from the shape body's wrapper, is only optional. The washing of the film before or during the drying is not necessarily required any more. The polyglycerols as hydrophilic substances with suitable chain length can be absorbed from the surface of the matrix respectively diffuse into the matrix at least at the surface. A molecule size of the polyglycerols of 2 to 10 monomeric units is especially suitable. Capsules covered with a thin film of polyglycerol do not adhere during the drying, probably due to the better wetting of the surface of the capsule respectively the surface tension, which avoids unnecessary loss of production. In particular it is of benefit to the drying process following the filling of the capsule, that the lightly hygroscopic polyol absorbs water from the capsule's wrapper and in general do not oppose a hydrophobic diffusion barrier to the drying process.

The polyglycerols show brilliant characteristics as sliding agents, seal well in the region of the warm filling wedge and support the thermomechanical welding of the capsule's halves. In particular for hydrophilic filling materials, for which the heat transference of a conventional hydrophobic lubricant can lead to an insufficient weldment joint and therefore to leakages, a hydrophilic lubricant on the base of polyglycerol is superior.

A further advantage of the use of polyglycerol in lubricants is, that the lattices of waste being coated on the surface with lubricant, can be supplied to a recycling when manufacturing shape bodies, particularly soft capsules. When melting, a hydrophilic lubricant forms a homogeneous phase being available for the recycling e.g. quite for the same process. Adherent residual filling material is tolerable, if the lattice of waste is recycled to shape bodies being filled with the same filling material.

As for example can be seen from the U.S. Pat. No. 5,362,564, polyglycerol is already used as softener e.g. in gelatin films. As far as the thermal or mechanical characteristics of the recycled lattices of waste, for example of gelatin, are changed due to the polyglycerols at all, this change takes place in a predicted and desired way. The polyglycerol brought in by the recycling of the lattices of waste range in view of the amount at a maximum of some percents respectively can be set like that. By adding a part of fresh biopolymer mass with a small amount of softener, which can also be composed of softeners other than polyglycerol, this effect is furthermore neutralised. Also ductors can be used to reduce the residue of polyglycerol adhering at the lattices of waste by stripping to a range of less than about 1%.

An extrusion or strip also according to the present invention is manufactured by casting, blowing, extrusion, a dropping respectively a dipping method. With that, e.g. due to the gel sol transition, the biopolymer mass can take on the necessary viscosity respectively strength or already has comprised this before (e.g. at extrudable mixtures).

Polyglycerols according to the present invention are oligomers with at most 28 monomeric units of glycerol HO—CH₂—CH(OH)—CH₂—OH, that result e.g. from a condensation reaction of glycerol by the formation of a polyether. Due to the technique of production, the oligomers are obtained in mixtures of different chain lengths. Therefore the specification of a certain oligomer, e.g. decaglycerol means a composition containing this certain oligomer by a majority. Therefore also parts of di-, tri- and further glycerols can still be present.

Still other routes of synthesis are also possible, e.g. the reaction of a starting molecule of glycerol with the corresponding (hydroxy methyl) oxiran. The condensation of glycerol leads with an increasing amount of linked monomers to an increasing amount of constitutional isomers branched any way due to the triple functionality of the glycerol monomer. It is also possible to carry out the condensation polymerisation with a glycerol partially derivatised by protective groups, wherein the monomers are only bifunctional and therefrom result unbranched polyethers.

Polyglycerols according to the present invention are characterized by their molecular weight, corresponding to the number of glycerol monomers being linked therein via ether bindings. (Lexikon der Hilfsstoffe, P. Fiedler, Edition Cantor Verlag Aulendorf, 1996). Whereas the monomer glycerol pure or as a mixture with other organic substances is only moderately suitable as a sliding agent, its higher homologues beginning from diglycerol are very suitable as lubricants in the rotary-die-method or a similar work process (see above). Polyglycerols according to the present invention are created by linking 2 to 28 glycerol monomers. They differ from glycerol in the salvation capacity and the viscosity increasing with the chain length. A polyglycerol according to the present invention is further liquid at ambient temperature and is mixable with water at ambient temperature in every proportion. Polyglycerols with a majority of oligomers of a molecular weight of 750 g/mol are still liquid. A preferred embodiment according to the present invention is decaglycerol.

As long as the characteristic as a lubricant respectively the water-solubility according to the items mentioned above is not affected, the polyglycerols also can be partially derivatised, e.g. esterified. Also mixtures of polyglycerols and polyglycerol derivatives, particularly polyglycerol esters can be used as lubricant.

A further advantage of the lubricant according to the present invention results if a retreatment of the capsule takes place to reach special characteristics as solubility controllable by time or pH-value in the stomach by films or coatings. For these applications, water-based coatings are preferred to prevent a handling with volatile organic solvents. The residues of polyglycerol e.g. on the surface of the capsule are compatible with such coatings. It is also possible to mix such coatings already to the lubricant, e.g. aqueous mixtures of polyglycerol and hydroxymethyl cellulose or other starch derivatives and cellulose derivatives, as far as the characteristics of the lubricant are not changed essentially thereby. Therefore, in a further preferred embodiment, the lubricant comprises a cellulose derivative, preferably a cellulose derivative suitable as a gastric acid resistant coating. An example for a gastric acid resistant coating made of a cellulose derivative is e.g. hydroxypropylmethyl-cellulose-acetatesuccinate (HPMCAS). In an aqueous solution HPMCAS is only soluble at a pH>5.

In a preferred embodiment, the lubricant additionally contains structural changing substances for the biopolymeric material, e.g. xylose for gelatin.

By adding hydroxymethyl propyl cellulose phthalate, cellulose phthalate, methyl methacrylate emulsions, it is also possible to generate a primer for the following deposition of lacquer. A lubricant according to the present invention additionally comprises water, organic substances homogeneously mixable with water or polyglycerol, organic substances dissolved in polyglycerol or water optionally by using an emulsifying agent, preferably cellulose derivatives, or organic solvents homogeneously mixable with water, alone or in any combination.

In a further preferred embodiment, the lubricant comprises aliphatic or cyclic alcohols, glycol, glycerol, propylene glycol or polypropylene glycol, ethylene glycol or polyethylene glycol alone or in combination. The addition of those hydrophilic substances makes the optimum co-ordination of the characteristic of a lubricant based on polyglycerol and the characteristics of the used biopolymer or the specific production requirements possible. Therewith the advantages of hydrophilic polyglycerols as lubricant are maintained. Particularly components as polyalkenyl glycols with sufficient chain length do not diffuse in the gel matrix.

Biopolymers like cellulose derivatives can serve as additional rheology setting additives. In many cases in the galenism watersoluble celluloses are used, that are derivatised by etherification with hydroxy-alkoxy groups or by esterification e.g. with phthalic acid.

Preferably the ratio of mixture of the polyglycerol in the lubricant amounts to at least 5% , in a preferred embodiment at least 15%, and in a most preferred embodiment at least 40% of the total weight.

In a further preferred embodiment, the polyglycerol or the mixture of polyglycerol of the lubricant according to the present invention consists of unbranched molecule chains. Such molecule chains show especially good characteristics of the sliding agent in a wide temperature range between about 5 to 50° C. and, due to the light structural viscosity, combine them with good sealing characteristics in the region of the filling wedge. The viscosity increases linear to the chain length; the addition or the single use of unbranched polyglycerols to the lubricants according to the present invention, therefore, makes the calculated manufacturing of a lubricant with the suitable viscosity possible, particularly in mixtures with the other substances mentioned above.

A further subject of the present invention is a method of manufacturing doses capsules using a water-soluble lubricant according to the items mentioned above, containing polyglycerol or a mixture of polyglycerol with 2 to 28 monomeric units, preferably 2 to 10 monomeric units, in a work process containing the conveyance of an extrusion, in particular a strip of a biopolymer, comprising the steps of generating at least one continuous first extrusion and at least one continuous second extrusion, of depositing a lubricant to at least one side of at least one extrusion, of combining the first and the second extrusion to shape bodies and of filling a filling material by the formation of a capsule's form and finally of drying the capsules.

Manufacturing methods described by these steps are e.g. the rotary-die-method and the accogel method. Both methods make possible the manufacturing of entirely closed shape bodies, particularly of capsules, from a huge number of film forming biopolymeric compounds, as e.g. gelatin or starch. However it is also possible to manufacture such capsules in the reciprocating-die-method (Norton) or in another continuous punching method by using gel strips or extrusions.

A further advantage of the method is the omission of an additional washing step to remove the lubricant adhering to the shape body. The water-soluble lubricant does not hinder the drying and prevents the capsules' adherence. The drying according to the present invention can be for example circulating air drying, however it can also be a drying e.g. at low pressure in the presence of a drying agent, or something similar. In any case the drying serves for the reduction of the content of the solvent in the gel matrix, preferably of the water content; thereby the shape body becomes compact.

Biopolymeric compounds according to the present invention usually contain softener, e.g. glycerol, polyglycerol, sorbitol, propylglycol, ditmethyl polysiloxane and ethylene glycol. It is possible to use film forming mixtures, which are composed of gelatin, cellulose or cellulose derivative, starch or another biopolymer, mixtures of them or at least partially of a biopolymer derivative or decomposition product.

It is also possible to clean the capsules before or during the drying from the residual lubricant remaining on the capsule's wrapper. Thereby, the advantage is that no organic solvents have to be used. It is easy to remove the lubricant from the surface of the capsules by means of harmless, hydrophilic liquids as e.g. (cold) water, alcohols, a mixture of those substances, or alternatively by a solid binder e.g. cotton cloths. Such methods of removing the thin film of lubricant remaining on the surface of the capsule are the subject-matter of the preferred embodiments of the method according to the present invention.

A further subject-matter of the present invention is at least the partial use of punching waste, arising from the manufacturing of soft capsules in a continuous method after punching out the capsules from one or more strips coated with lubricant, as a starting material for manufacturing strips, wherein the lubricant is water-soluble or water dispersible and comprises one or more polyglycerols preferably with 2 to 28 monomeric units.

A further subject-matter of the present invention is the use of biopolymeric materials, that are mixed with a water-soluble or water dispersible lubricant, which comprises one or more polyglycerols, preferably with 2 to 28 monomeric units, and arise as waste from a first work process of manufacturing shape bodies, in a second work process.

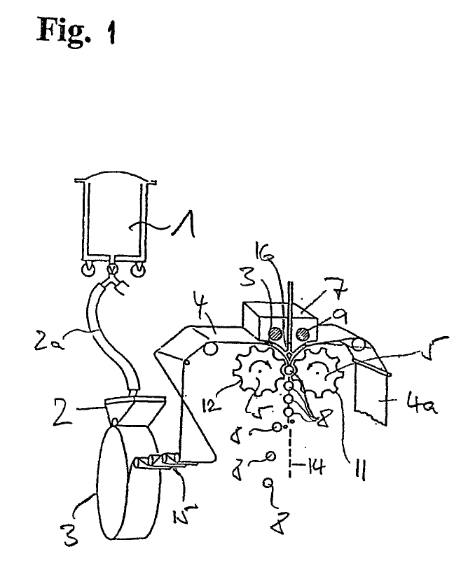

FIG. 1 schematically shows the rotary-die-method.

The rotary-die-method bases on a encapsulating device with rotating shaping rollers 5,5a. Here the single-step manufacturing is characteristic. The production of the capsule's wrapper, its filling as well as the punching of the capsules is performed in one single device, as it is shown in FIG. 1.

From a gelatin storage container 1 containing the gelatin sol with additives as e.g. softeners in liquid form at 60-70° C., a endless rubber-like elastic strip of about 0.8 mm in thickness in the average is casted over a special strip casting device 2 (with a supply device 2a) on a cooling drum 3. On the cooling drum 3, working in a temperature range of 5 to 25° C., the transition to the gel takes place. Hereby the exact cooling temperature is an important parameter of the process to control the characteristics, i.e. the elasticity, of the gel strip 4,4a. The cooling drums 3 are provided with plane surfaces, that are usually not lubricated. The gelatin strip 4,4a generated on the cooling drum 3 is then supplied tension-free over several lubrication rollers 15 and deflection rollers to the shaping rollers 5,5a. The lubrication rollers 15 are provided with e.g. a absorbent surface and can be supplied from an inner void volume with the lubricant. However also other means of depositing the lubricant on the gelatin strip are possible, as dipping, sinter feed roller, etc.

The gelatin strip 4 is transported with a speed of about 1-2 m/min, wherein single rollers can be provided with driving devices.

Over respectively between the shaping rollers 5,5a the filling wedge 7 is working, by means of which the filling material 16 gets into the capsules 8 and which integrated thermoelements 9 emit the seal heat for the welding of the capsule halves made of the both gelatin strips 4, 4a. By pressing together, the counter-rotating shaping rollers 5, 5a, provided with the recesses 12, build flat pocket-like formations from the gelatin strips 4a,4. The recesses 12 correspond to the capsule's shape, along which the gel strips 4, 4a are welded.

Just before the entire closing of the gel pocket, being defined by this recess 12, the filling material 16 is pressed in these pockets through the filling wedge 7, wherein the capsule 8 takes on its actual shape. The roller pressure on the edges 11 of the recess 12 further causes the punching of the capsules 8. The gap 13 between the converging gelatin strips 4, 4a and the filling wedge 7 is sealed by accumulated lubricant. This sealing function is essential for the correct filling of the capsule 8. In the gap 13 the lubricant transmits the heat of the thermoelements 9 from the filling wedge 7 to the surface of the gelatin strips 4, 4a to be welded. Therefore the lubricant has to show suitable lubrication characteristics in a temperature range of 20° C. (on the rollers 15) to the heating temperature of about 40° (at the filling wedge 7). A hydrophilic lubricant shows less interference with the welding of a humid matrix of the gelatin strips 4, 4a. The remaining gelatin strip after the punching of the capsules, which is called lattice of waste 14, is contaminated with the lubricant on the surface. Conventional lubricants (mineral oils respectively triglycerides), do not allow the recycling of the lattice of waste 14 by melting to the sol. However polyglycerols as hydrophilic lubricant are mixed homogeneously with the gelatin mass during melting and do not affect adversely the characteristics of the gelatin strips 4, 4a produced therefrom respectively in prescribable way and extent, as polyglycerol is known from the prior art as a softener for soft gelatin capsules. For example it is possible to mix the gelatin mass in the storage container 1 partially with lattices of waste 14 and fresh material with a lower amount of softener. Thereby the admixtures of polyglycerol resulting from the lubricant do not become apparent in a disturbing way.

### EXAMPLE 1

A lubricant according to the present invention is produced by mixing of three parts by weight dekaglycerol (producer: Sakamoto Yakuhin Kogyo C. Ltd.) with one part by weight water. By the use of this lubricant, soft gelatin capsules were produced according to the rotary-die-method. The resulting capsules show a very well formed weld-seam, can be dried quickly, show dimensional stability and do not adhere.

### EXAMPLE 2

A lubricant according to the present invention is produced by mixing of two parts by weight hexaglycerol with two parts by weight water. By the use of this strip sliding agent, soft gelatin capsules were produced according to the rotary-die-method. Again The resulting capsules show a very well formed weld-seam, can be dried quickly and show dimensional stability.

### EXAMPLE 3

A lubricant according to the present invention is produced by mixing of three parts by weight hexaglycerol with one part by weight PEG 400 (400=molecular weight). By the use of this strip sliding agent, soft gelatin capsules were produced according to the rotary-die-method. The resulting capsules show a very well formed weld-seam, can be dried quickly and show dimensional stability.

1. Use of a water-soluble agent containing at least a polyglycerol, preferably from 2 to 28 monomeric units, for the lubrication of extrusions, in particular strips, made of at least one biopolymeric substance in a work process containing at least the conveyance of the extrusions, in particular in a process of manufacturing capsules.

2. Agent for the lubrication according to claim 1, characterized in that the agent for the lubrication additionally comprises water, organic substances homogeneously mixable with water or polyglycerol, organic substances dissolved in polyglycerol or water optionally by using an emulsifying agent, preferably cellulose derivatives, or organic solvents homogeneously mixable with water, alone or in any combination.

3. Agent for the lubrication according to claim 2, characterized in that the organic substances homogeneously mixable with water or polyglycerol comprise aliphatic and/or cyclic alcohols, glycol, glycerol, propylene glycol and/or polypropylene glycol, ethylene glycol or polyethylene glycol, alone or in combination.

4. Agent for the lubrication according to claim 2, characterized in that additional structural changing substances for the biopolymeric substance are included.

5. Use of an agent for the lubrication according to any preceding claim for the manufacturing of a capsule preferably coated to provide gastric acid resistance, characterized in that the lubricant comprises a cellulose derivative, preferably a cellulose derivative suitable as a gastric acid resistant coating.

6. Agent for the lubrication according to any preceding claim, characterized in that the ratio of mixture of the polyglycerol in the lubricant is at least 5% of the total weight, preferably at least 15% of the total weight, and most preferably at least 40% of the total weight.

7. Agent for the lubrication according to any preceding claim, characterized in that the polyglycerol is unbranched.

8. Agent for the lubrication of at least one extrusion, in particular one strip, made of a biopolymeric substance in a work process containing at least the conveyance of an extrusion, characterized in that the lubricant is water-soluble and comprises one or more polyglycerols from 2 to 28 monomeric units and a cellulose derivative, preferably a cellulose derivative suitable as a gastric acid resistant coating.

9. Agent according to claim 8, characterized in that the ratio of mixture of the polyglycerol in the lubricant is at least 5% of the total weight, preferably at least 15% of the total weight, and most preferably at least 40% of the total weight.

10. Method of manufacturing dose capsules using a water-soluble lubricant containing polyglycerol or a mixture of polyglycerol with 2 to 28 monomeric units, preferably 4 to 10 monomeric units, in a work process containing the conveyance of an extrusion, in particular a strip, of a biopolymer, comprising the steps of
generating at least one continuous first extrusion and at least one continuous second extrusion;
depositing a lubricant on at least one side of at least one extrusion;
combining the first and the second extrusion to shape bodies and of filling a filling material under the formation of a capsule's form; and
drying the capsules.

11. Method according to claim 10, characterized in that the removal of the lubricant by means of water, an alcohol or a mixture of these substances is carried out in an additional operation step before drying.

12. Method according to claim 10, characterized in that the removal of the lubricant is carried out by means of a solid binder, preferably cotton cloths, in an additional operation step before or during the drying.

13. Use of punching wastes, arising from the manufacturing of soft capsules according to a continuous method, preferably the rotary-die-method, after the punching of the capsules from one or more strips being coated with lubricant, at least partially as starting material for manufacturing said strips, wherein the lubricant is water-soluble and contains at least one polyglycerol having 2 to 28 monomeric units.

14. Use of wastes of a first work process, containing a biopolymeric substance and being mixed with a water-soluble lubricant, comprising at least a polyglycerol having 2 to 28 monomeric units, for manufacturing a product, preferably a shape body, in a second work process.

15. Agent for the lubrication according to any of claims 1 to 7, characterized in that the biopolymeric substance is gelatin or starch or contains gelatin or starch.
